(19) United States
(12) Patent Application Publication
(10) Pub. No.: US 2023/0228149 A1
(43) Pub. Date: Jul. 20, 2023

(54) TREE CLIMBING STICK CLIP

(71) Applicant: Double Dragon International, Inc., Dubuque, IA (US)

(72) Inventor: Randy L. SCHOFIELD, Harrisburg, MO (US)

(21) Appl. No.: 18/157,327

(22) Filed: Jan. 20, 2023

Related U.S. Application Data
(60) Provisional application No. 63/301,134, filed on Jan. 20, 2022.

(51) Int. Cl. E06C 1/38; E06C 1/34; E06C 7/50

(52) U.S. Cl. CPC E06C 1/381; E06C 1/34; E06C 7/50

(57) ABSTRACT

A clip for releasably connecting multiple climbing sticks in parallel may include a pair of resiliently flexible grippers that form a channel that is sized to receive a post of a climbing stick while the pair of spaced resiliently flexible grippers grip opposite sides of the post of the climbing stick.

### CROSS-REFERENCE TO RELATED PATENT APPLICATIONS

The present application patent application claiming priority under 35 USC 119 from co-pending U.S. Provisional Pat. Application Serial No. 63/301,134 filed on Jan. 20, 2022, by Schofield et al. and entitled TREE CLIMBING STICK SYSTEM, the full disclosure of which is hereby incorporated by reference.

### BACKGROUND

Tree climbing sticks are typically mounted end-to-end along a tree and serve as a ladder for a climber to reach a higher tree stand for wildlife observation or hunting. As such tree climbing sticks are frequently used in remote areas, transporting such tree climbing sticks is often difficult.

### BRIEF DESCRIPTION OF THE DRAWINGS

FIG. 1 is a perspective view illustrating portions of an example tree climbing stick having a pair of example clips.

FIG. 2 is an enlarged perspective view illustrating the example clips of FIG. 1.

FIG. 3 is a perspective view illustrating a plurality of the climbing sticks of FIG. 1 connected to one another by clips.

FIG. 4 is a front view illustrating portions of an example climbing stick having an example clip.

FIG. 5 is a rear perspective view of the example climbing stick of FIG. 4.

FIG. 6 is a perspective view illustrating the example clip of FIG. 4.

FIG. 7 is a front view of the example clip of FIG. 6, illustrating examples (in broken lines) of how the example clip may be connected to another climbing stick.

FIG. 8 is a perspective view illustrating a plurality of the climbing sticks of FIG. 4 joined by clips.

FIG. 9 is an enlarged fragmentary perspective view of the climbing sticks of FIG. 8.

FIG. 10 is an enlarged fragmentary perspective view illustrating another example of how the climbing sticks of FIG. 8 may be joined using one of the example clips and a cinch mount.

FIG. 11 is an enlarged fragmentary perspective view illustrating the connected climbing sticks of FIG. 10.

FIG. 12 is a front view of an example clip that may be used as part of any of the described climbing sticks.

FIG. 13 is an enlarged view of a portion of the clip of FIG. 12.

FIG. 14 is a front perspective view illustrating portions of an example climbing stick with an example clip.

FIG. 15 is a front perspective view illustrating a plurality of the climbing six of FIG. 14 connected to one another by example clips.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

Disclosed are example tree climbing stick systems, tree climbing sticks and tree climbing stick clips. The example clips may be connected to the tree climbing sticks and facilitate releasable connection of multiple tree climbing sticks of a climbing stick system in a parallel or side-by-side arrangement. As result, the multiple tree climbing sticks may be easier to store and easier to transport.

The clips may be mounted to the climbing sticks in a fashion such that the clips cannot be inadvertently detached from the climbing sticks. As result, the individual tree climbing sticks are releasably connected to one another without extraneous or additional fasteners or other components which might otherwise become separated and lost when the climbing sticks are separated and being used.

The example clips further serve as buffers or spaces between the inner connected climbing sticks. The example clips may protect the clips from abrasion during transport. Moreover, in implementations where the climbing sticks are largely formed from metal, some of the example clips may be formed from a polymer, reducing noise during transport.

The example clips include pairs of resiliently flexible grippers that form a channel facing in a direction and sized to receive a post of a climbing stick while the pair of spaced resiliently flexible grippers grip opposite sides of the post of the climbing stick. In some implementations, the clips include a second pair of resiliently flexible grippers forming a second channel on the opposite side of the post that is sized to receive a second post of a second climbing stick while the second pair of resiliently flexible grippers grip opposite side of the second post of a second climbing stick. As result, clips facilitate interconnection of other climbing sticks on both opposite sides of the climbing stick.

In some implementations the clips are rotatably mounted to the post of the climbing stick. The clips may be rotated to a non-use position in which the clips are aligned with a longitudinal length of the post and wherein the clips have a horizontal width (perpendicular to the longitudinal axis of the post) that is less than the width of the post so as to not protrude beyond edges of the face of the post that support the clip. The clips may be rotated to a gripping position in which the clips generally extend perpendicular to the longitudinal axis of the post such that the horizontal width of the clips protrudes beyond edges of the face of the post that support the clip.

In some implementations, the grippers of the clips project from a body that is in the form of a sleeve that receives post. In such an implementation, the sleeve may be slidable along the post between various positions along the post. In some implementations, the sleeves continuous. In other implementations, sleeve may be broken, having end portions that may hook to one another. In some implementations, sleeve may provide with a hinge to facilitate opening and closing of the sleeve for the reception of a post.

In some implementations, the clips may comprise a cinch mount head connector. The cinch mount head connector is configured to receive a cinch mount head in some implementations, cinch mount head connector may also be for from a resiliently flexible material, wherein the cinch mount head connector grips a neck supporting the cinch mount head.

The example clips may be utilized with climbing sticks having two steps, three steps or greater than three steps supported along a length of the post. In some implementations, a post may be provided with multiple clips. In some implementations, each of the individual steps laterally projects from both opposite sides of the post. In some implementations, each of the manual steps is rotatable between a leftward extending position, a rightward extending position and an aligned position aligned with the longitudinal axis of the post for compact storage and transport.

For purposes of this disclosure, the term “coupled” shall mean the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate member being attached to one another. Such joining may be permanent in nature or alternatively may be removable or releasable in nature.

For purposes of this disclosure, the phrase “configured to” denotes an actual state of configuration that fundamentally ties the stated function/use to the physical characteristics of the feature proceeding the phrase “configured to”.

For purposes of this disclosure, the term “releasably” or “removably” with respect to an attachment or coupling of two structures means that the two structures may be repeatedly connected and disconnected to and from one another without material damage to either of the two structures or their functioning.

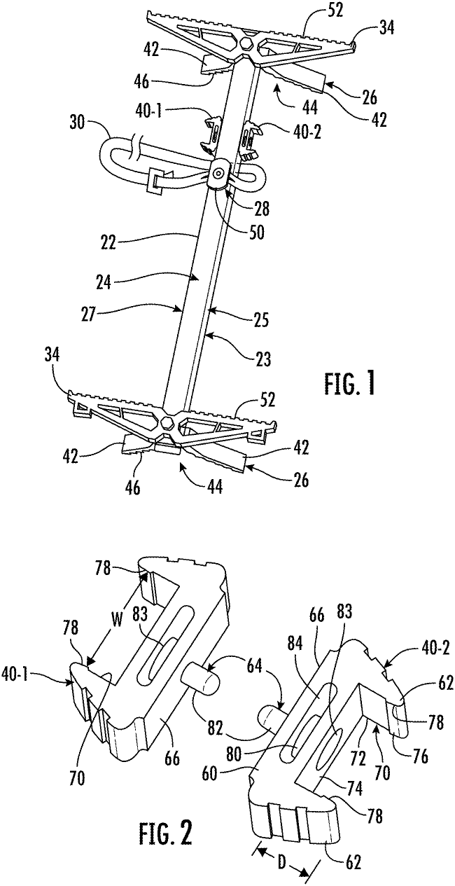

FIG. 1 is a perspective view illustrating portions of an example climbing stick 20. Climbing stick 20 may be utilized with other similar climbing sticks which are mounted in an end-to-end fashion along a tree trunk to form a ladder to facilitate climbing of a tree. Climbing stick 20 comprises post 22, tree gripping claws 26, cinch mount 28, cinch 30, steps 34 and clips 40-1, 40-2 (collectively referred to as clips 40).

Post 22 comprises an elongate tube formed from a relatively strong and rigid material, such as a metal, such as aluminum or steel. Post 22 has a back side 23, a front side 24, a right side 25 and a left side 27. Back side 23 is located so Sue face a tree when climbing stick 20 is mounted along a tree. In the example illustrated, post 22 has a square or rectangular cross-sectional shape. Post 22 facilitates removable mounting of tree gripping claws 26, cinch mount 28, cinch 30, steps 34, and clips 40 at various locations along its length. As a result, such components may be more easily replaced when worn or damaged or may be more easily exchanged when components of climbing stick 20 are being updated are customized.

In other implementations, post 22 may have other configurations. For example, in other implementations, post 22 may be integrally formed as a single unitary body with one arm or of the other components of stick 20. In other implementations, post 22 may be formed through a casting process, wherein post 22 is integrally formed as a single unitary body with one or more of the other components of stick 20. In other implementations, in lieu of comprising a tube, post 22 may comprise a single solid bar, an I-beam or other supporting structure.

Tree gripping claws 26 comprise structures that engage and grip the sides of a tree to which climbing stick 20 is to be mounted. Tree gripping claws 26 comprise a generally V-shaped bracket removably coupled or secured to back side 23 of post 22, projecting away from back side 23. Each of tree gripping claws 26 has wings 42 that form a V-shaped opening 44 for receiving a side of a tree. In the example illustrated, each of wings 42 further comprises teeth 46 for enhanced gripping of the engaged tree.

Cinch mount 28 extends from front side 24 of post 22 and comprises a cinch retaining head 50 and intervening neck extending between post 22 and head 50. Cinch mount 28 facilitates the securement of cinch strap 30. In the example illustrated, cinch strap 30 comprises a split along the strap to insert over head 50 so as to extend about the neck, with strap 30 being captured between the post 22 and the head 50. Cinch strap 30 facilitates further securement and retention of climbing stick 20 vertically along a tree.

Steps 34 each comprise a rigid platform coupled to front side 24 of post 22 so as to provide a foot supporting surface as a climber is using climbing stick 20 to ascend a tree. In the example illustrated, each step 34 comprises a single integrally formed body projecting both to the right and to the left of post 22. Each step 34 includes a plurality of upwardly facing teeth 52 to inhibit slipping of a climber’s foot relative to step 34. In the example illustrated, each of steps 34 is bolted to post 22. In other implementations, steps 34 may have other sizes, shapes and may be coupled to post 22 at other locations and in other fashions.

Clips 40 comprise components that are configured to releasably secure posts of other similar climbing sticks, facilitating the linking or interconnection of multiple climbing sticks as a set for storage and transport. Clip 40-1 is coupled to post 22 on the left side 27 of post 22. Clip 40-2 is coupled to post 22 on the right side 25 of post 22.

FIG. 2 is an enlarged view illustrating clips 40. As shown by FIG. 2, clips 40-1 and 40-2 are substantially identical to one another in face in opposite directions. Each of clips 40 comprises body 60, grippers 62 and clip mount 64. Body 60 comprises a structure that serves as a platform base for grippers 62. Body 60 supports mount 64 and has a surface 66 that is complementary to the left and right sides 25, 27 of post 22. For example, where post 22 is square or rectangular, surface 66 is flat so as to mate and abut against the flat surface of sides 25 and 27. In other implementations where post 22 is oval or circular, surface 66 may be curved. In other implementations where sides 25 and 27 have grooves, indentations or other shapes, surface 66 may likewise have complementary or mating shapes.

Grippers 62 comprise fingers or other protuberances that project from body 60 and that form a channel 70 therebetween. Channel 70 has sides 72 defined by grippers 62 and a floor 74 defined by body 60. Channel 70 is sized to receive the post of a second climbing stick with the pair of grippers 62 gripping opposite sides of the post of the second climbing stick. Channel 70 has a width W corresponding to a width of the post of the second climbing stick. In the example illustrated in which each of the climbing sticks of the climbing stick system are identical to one another and are interchangeable with one another, channel 70 has a width W corresponding to the width of side 23 or side 27 of post 22. Channel 70 has a cross-sectional shape corresponding to the cross-sectional shape of the received post 22. In the example illustrated, channel 70 has a square or rectangular cross-sectional shape. In other implementations where the post has an oval or circular cross-sectional shape, channel 70 may likewise have an oval or circular cross-sectional shape.

Each of channels 70 has a depth D sufficient to reliably retain a received post 22. In the example illustrated, each of channels 70 has a depth of at least 25% of the width of back side 23 or front side 24 of post 22 and, in some implementations, at least about 28% of the width of back side 23 are front side 24 post 22. In some implementations, each of channels 70 has a depth of at least 0.25 inches.

In the example illustrated, grippers 62 are resiliently flexible. In such implementations, channel 70 may have a mouth 76 sized to be slightly smaller than the width of the climbing stick post to be received. In such implementations, gripper 62 may resiliently stretch or expand outwardly during reception of the post and then resiliently press against sides 23 and 24 of the received post to better grip the post. In the example illustrated, grippers 62 may include inwardly projecting teeth 78 at or near the tips of such grippers 62 for enhanced gripping.

In some implementations, grippers 62 are formed from a material or have a construction so as to have an elasticity or elastic modulus of at least 0.001 GPa and no greater than 20.0 GPa. Grippers 62 may have a durometer of 40-95 Shore A and 45-90 Shore D. This elasticity and durometer (softness) facilitates insertion of the post into channel 70 and secure retention of the post within channel 70 once received. In other implementations, grippers 62 may have other elastic modulus and/ or durometers.

In the example illustrated, body 60 is formed from a compressible material having an elasticity or elastic modulus of at least 0.001 GPa and no greater than 20.0 GPa. Body 60 may have a durometer of 40-95 Shore A and 45-90 Shore D. This compressibility and/or softness may cushion the received post of the connected climbing stick to better grip the receipt climbing stick in to inhibit noise generation. In one example implementation, body 60 and grippers 62 are integrally formed as single unitary body. In other implementations, body 60 and grippers 62 may be separate components bonded, fused, welded, interlocked or fastened to one another. In the example illustrated, body 60 and grippers 62 are formed from a rubber or a rubber-like material such as ethylene propylene diene monomer (EPDM). In other implementations, body 60 and grippers 62 may be formed from other materials.

Clip mounts 64 comprises mechanisms configured to connect clips 40 adjacent to and along sides 23 and 27 of post 22. In the example illustrated, each of mounts 64 comprises a fastener that projects through body 60 into post 22. Each of mounts 64 has a head 80 recessed below floor 74 of channel 70 and a shaft portion 82 that projects beyond surface 66 and into engagement with post 22. In the example illustrated, floor 74 of channel 70 comprises a fastener opening 83 through which mount 64 may be inserted into a head receiving cavity 84 form between surface 66 and floor 74. Head 80 has an outer diameter greater than the passage (not shown) through a shaft portion 82 extends through the remainder of body 60. In the example illustrated, each of mounts 64 may be in the form of a rivet, wherein the tip of shaft portions 82 are expanded once inserted through an opening in post 22 so as to secure mount 64 and the remainder of clip 40 to the post 22. In other implementations, shaft portion 82 may be externally or internally threaded to receive a nut for securing the associated clip 40 to post 22.

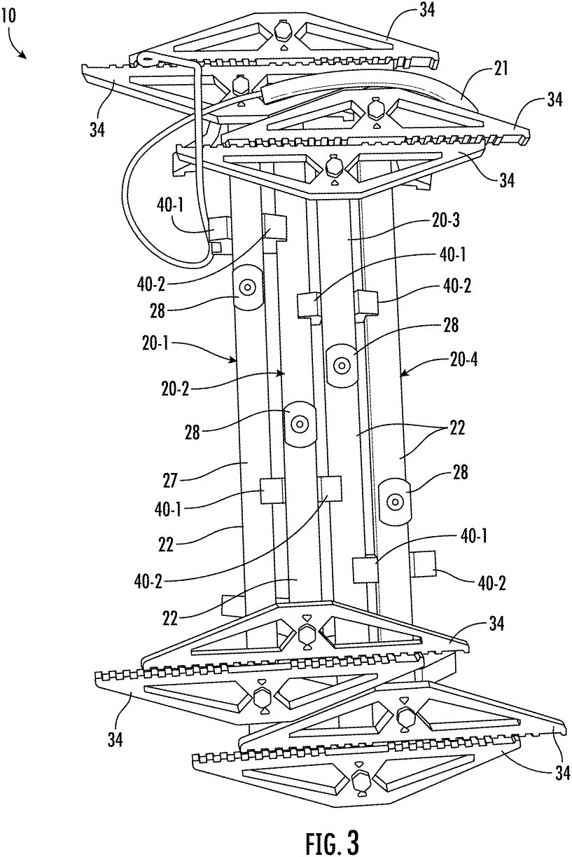

In the example illustrated, mounts 64 rotatably couple clips 40 to post 22 for rotation about the axes of shaft portions 82. Each of clips 40 is rotatable between a first non-use position shown in FIG. 1 in which a centerline of channel 70 extends perpendicular to the centerline of post 22 and a second post interconnecting position (shown in FIG. 3 in which the centerline of channel 70 extends parallel to the centerline of post 22. As shown by FIG. 1, when in the first non-use position, each of clips 40 is contained between rear side 23 and front side 24 of post 22, not projecting beyond rear side 23 or front side 24 of post 22. As a result, clips 40 do not project towards the rear of post 22 where they might otherwise confront a tree surface and do not project beyond the front of post 22 where they might otherwise catch or snag against other articles when climbing stick 20 is being used to ascend a tree.

As shown by FIG. 3, in the second post interconnecting position, each of clips 40 projects beyond the backside 23 and the front side 24 of post 22 such that the centerlines of channel 70 are aligned or parallel with the longitudinal length of adjacent post 22 of adjacent climbing sticks 20. FIG. 3 illustrates an example climbing stick system 10 formed by four identical climbing sticks 20-1, 20-2, 20-3 and 20-4 (collectively referred to as sticks 20) interconnected to one another by a series of clips 40 oriented in the second post interconnecting positions. FIG. 3 further illustrates an example climbing stick aider 21 which comprises a flexible step to be suspended from a lowermost step 34 of the lowermost climbing stick 20 of the ladder formed by climbing sticks 20 when climbing sticks 20 are supported along a tree in an end-to-end fashion. FIG. 3 illustrates clips 40 receiving the posts 22 of tree climbing sticks 20 while the grippers 62 of the clips 40 grip against the backside 23 and the front side 27 of the respective posts 22. As shown by FIG. 3, clips 40 facilitate the interconnection of tree climbing sticks 20 as a single interconnected unit are set that is relatively compact for ease of storage and transport.

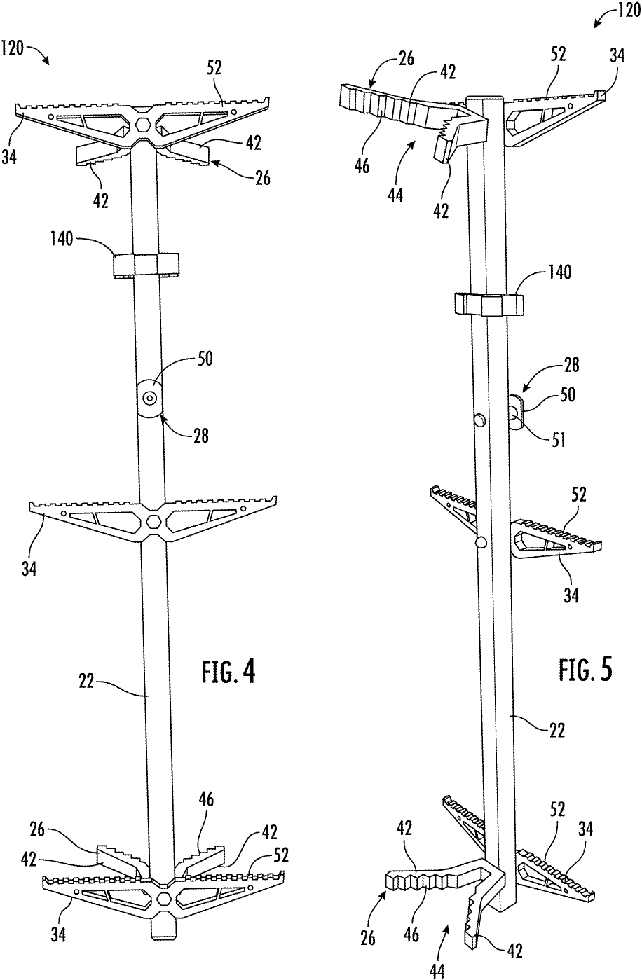

FIGS. 4 and 5 illustrate portions of an example climbing stick 120. Climb stick 120 is similar to climb stick 20 described above except that climbing stick 120 comprises a longer post 22 supporting an additional middle step 34 and comprises a differently configured clip 140. Those remaining components of climb stick 120 which correspond to components of climb 620 are numbered sim ilarly.

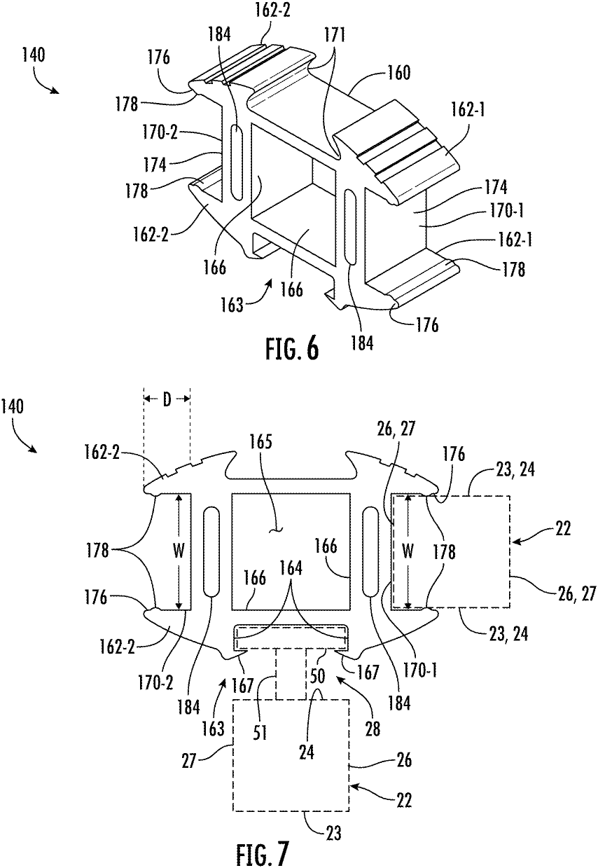

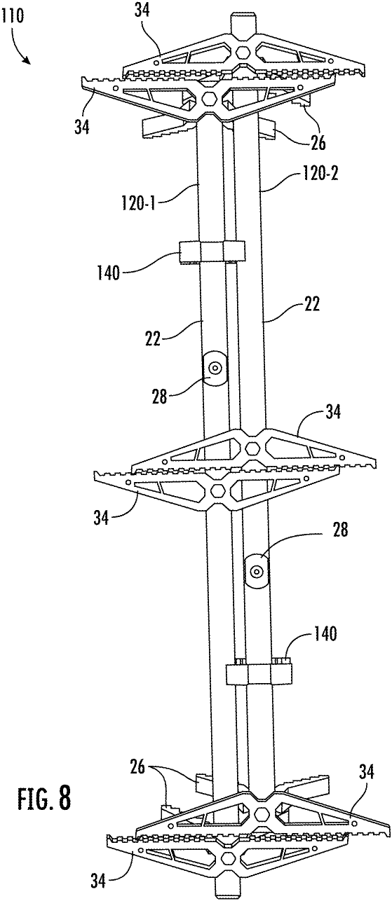

Clip 140 is configured to releasably secure posts of other similar climbing sticks, facilitating the linking or interconnection of multiple climbing sticks as a set for storage and transport. FIGS. 6 and 7 illustrate clip 140 in detail. As shown by FIGS. 6 and 7, clip 140 comprises body 160, grippers 162-1, 162-2 (collectively referred to as grippers 162) and cinch mount head connector 163.

Body 160 is in the form of a tube or sleeve configured to wrap about or extend about post 22 (as shown in FIGS. 4 and 5) in an uninterrupted fashion, without breaks. Body 160 comprises an interior passage 165 through which post 22 extends. In some implementations, interior passage 165 is sized and/or formed from material to facilitate sliding of clip 140 along post 22 to a desired position along post 22. Body 160 supports grippers 162 and 164.

Body 160 has interior surfaces 166 that are complementary to the corresponding exterior sides of post 22. For example, where post 22 is square or rectangular, surfaces 166 are flat so as to mate and abut against the flat surface of sides 23 and 27. In other implementations where post 22 is oval or circular, surfaces 166 may be curved, wherein body 160 may be in the form of a sleeve having an oval or circular interior cross-section. In other implementations where sides 23 and 27 have grooves, indentations or other shapes, surfaces 166 may likewise have complementary or mating tongues, projections or other mirroring shapes, respectively.

In the example illustrated, body 160 comprises openings 184, similar to openings 84 of clips 40. Openings 184 do not receive fasteners but facilitate flexing and deformation of floors 174 of channels 170. Such deformation may facilitate a softer floor 174 for noise reduction and may facilitate inward gripping of grippers 162.

Grippers 162-1 and 162-2 project from opposite sides of body 160. Each of grippers 162-1 and 162-2 has a configuration similar to that of grippers 62 described above. Grippers 162-1 are spaced so as to form a channel 170-1 sized to receive the post of a second climbing stick with the pair of grippers 162-1 gripping opposite sides of the post of the second climbing stick. Channel 170-1 has a width W corresponding to a width of the post of the second climbing stick. In the example illustrated in which each of the climbing sticks of the climbing stick system are identical to one another and are interchangeable with one another, channel 70 has a width W corresponding to the width of side 25 or side 27 of post 22 (shown in broken lines in FIG. 7).

Grippers 162-2 are spaced so as to form a channel 170-2 sized to receive the post of a third climbing stick with the pair of grippers 162-2 gripping opposite sides of the post of the third climbing stick. Channel 170-2 is similar to channel 170-1 except that channel 170-1 faces in a first direction while channel 170-2 faces in a second opposite direction. Channels 170 each has a cross-sectional shape corresponding to the cross-sectional shape of the received post 22. In the example illustrated, channels 170 each has a square or rectangular cross-sectional shape. In other implementations where the post 22 has an oval or circular cross-sectional shape, each of channels 170 may likewise have an oval or circular cross-sectional shape.

Each of channels 170 has a depth D sufficient to reliably retain a received post 22. In the example illustrated, each of channels 170 has a depth of at least 25% of the width of back side 23 or front side 24 of post 22 and, in some implementations, at least about 28% of the width of back side 23 are front side 24 post 22. In some implementations, each of channels 170 has a depth of at least 0.25 inches.

In some implementations, only one of channels 170-1, 170-2 may be utilized when multiple climbing sticks are interconnected to one another as a set or unit. The provision of the opposite facing channels 170-1, 170-2 provides flexibility with respect to the relative orientation and positioning when adjacent climbing sticks are being interconnected as a set or unit. In some implementations, clip 140 may omit one of channels 170.

In the example illustrated, grippers 162 are resiliently flexible. In such implementations, channels 170 may each have a mouth 176 sized to be slightly smaller than the width of the climbing stick post 22 to be received. In such implementations, grippers 162 may resiliently stretch or expand outwardly during reception of the post and then resiliently press against sides 23 and 24 of the received post to better grip the post 22. In the example illustrated, grippers 62 may include inwardly projecting bumps or teeth 178 at or near the tips of such grippers 162 for enhanced gripping.

In some implementations, grippers 162 are formed from a material or have a construction so as to have an elasticity or elastic modulus of at least 0.001 GPa and no greater than 20.0 GPa. Grippers 162 may have a durometer of 40-95 Shore A and 45-90 Shore D. This elasticity and durometer (softness) facilitates insertion of the post into channel 70 and secure retention of the post within channels 170 once received. In other implementations, grippers 162 may have other elastic modulus and/ or durometers.

In the example illustrated, clips 140 comprises notches or undercuts 171 which cut into a junction of body 160 and those grippers 162-1 and grippers 162-2 that extends on an opposite side of body 160 as cinch mount connector 163. Undercuts 171 assist in forming a living hinge, facilitating pivoting of those grippers 162 that are opposite to cinch mount head connector 163. In other implementations, undercuts 171 may be omitted. In some implementations, the side of clip 140 containing undercuts 171 may alternatively comprise a second cinch mount head connector 163.

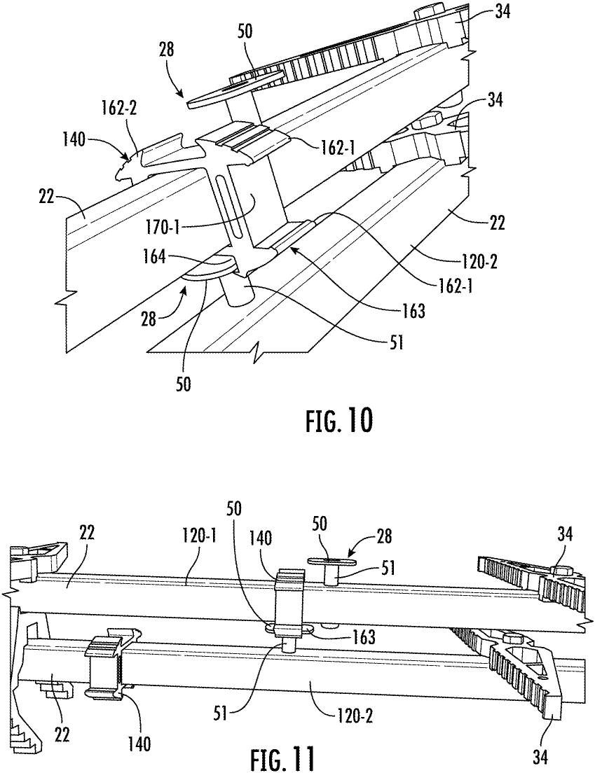

Cinch mount head connector 163 is located on a side of body opposite that of undercuts 171. Cinch mount head connector 163 comprises a head receiving channel 164 sized and shaped slidably receive the head of a cinch mount, such as head 50 of cinch mount 28 shown in FIGS. 4 and 5. In the example illustrated, cinch mount head connector 163 comprises a pair of opposite overhangs 167 which project beneath head 50, towards the neck of the cinch mount 28 (as seen in FIG. 10). In some implementations, overhangs 167 are resiliently flexible so as to tightly grip the received head 50. In other implementations, overhangs 167 are less flexible than grippers 162 such that head 50 may be not me withdrawn from channel 164 by pulling head 50 in a direction perpendicular to post 22, through the space between overhangs 167.

In the example illustrated, body 160 is formed from a compressible material having an elasticity or elastic modulus of at least 0.001 GPa and no greater than 20.0 GPa. Body 160 may have a durometer of 40-95 Shore A and 45-90 Shore D. This compressibility and/or softness may cushion the received post of the connected climbing stick to better grip the receipt climbing stick and to inhibit noise generation. In one example implementation, body 160 and grippers 162 are integrally formed as single unitary body. In other implementations, body 160 and grippers 162 may be separate components bonded, fused, welded, interlocked or fastened to one another. In the example illustrated, body 160 and grippers 162 are formed from a rubber or a rubber-like material such as ethylene propylene diene monomer (EPDM). in other implementations, body 160 and grippers 162 may be formed from other materials.

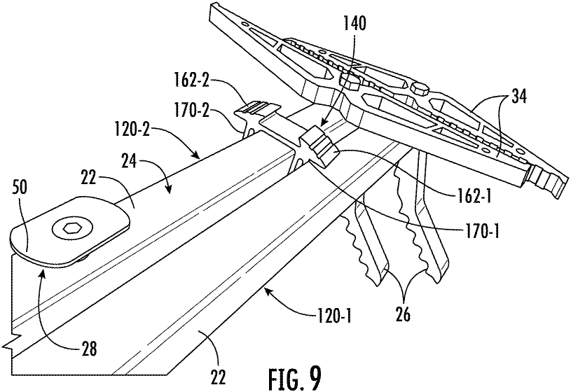

FIGS. 8 and 9 illustrate an example climbing stick system 110 formed by two climbing sticks 120-1 and 120-2, each identical to climbing sticks 120, being releasably joined to one another by their respective clips 140 at two spaced apart locations. FIG. 9 is an enlarged view illustrating the interconnection of climbing sticks 120-1 and 120-2. As shown by FIG. 9, channel 170-1 of clip 140, carried by with climbing stick 120-1, is receiving the post 22 of climbing stick 120-2. Grippers 162-1 of clip 140 abut against and grip back side 23 and front side 24 of post 22 of climbing stick 120-2.

FIGS. 10 and 11 illustrate the same to climbing one-being interconnected by clips 140 of climbing stick 120-1, wherein head 50 of climbing stick 120-2 is slidably received within channel 164 of cinch mount head connector 163 of clip 140.

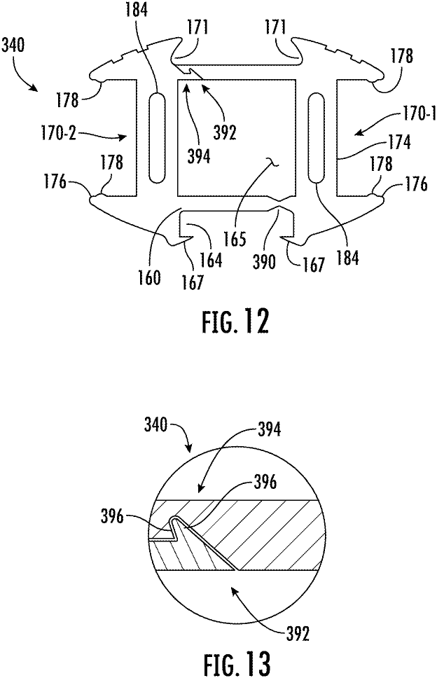

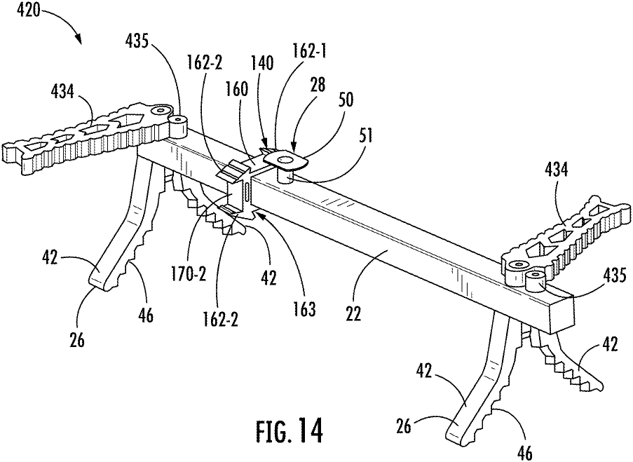

FIGS. 12 and 13 illustrate portions of an example clip 340 which may be utilized in place of clip 140 on climbing stick 120. Clip 340 is similar to clip 140 described above except that clip 140 is configured to be mounted upon post 22 while both ends of post 22 are blocked, such as by claws 26 and/are steps 34. Once mounted, clip 340 may be slidable along portions of the length of post 22.

As shown by FIG. 12, clip 340 comprises hinge 390 and a break 392 in the sleeve form by body 160. Hinge 390 and break 392 permit the sleeve formed by body 160 to be opened along its axial length, wherein opposite portions of sleeve or body 160 along break 392 may be pulled apart or separated to receive post 22 in a sideways manner. The sideways insertion of clip 340 about post 22 facilitates mounting of clip 140 to post 22 even while both ends of post 22 are blocked. In the example illustrated, hinge 390 comprises a thinner region of body 160 along the tube receiving passage of body 160, the thinner region forming what may be referred to as a “living hinge” in which the portions are bendable or flexible to allow opening of the sleeve along break 392. In other implementations, mechanical or other forms of a hinge may be employed.

As shown by FIG. 13, in the example illustrated, the 340 may additionally comprise a break connector 394 to connect those opposite portions of body 160 along break 392 once clip 340 has been positioned about post 22. In the example illustrated, brake connector 394 comprises a pair of inner lockable teeth or hooks 396 formed on opposite sides of the break 392. Hooks 396 are configured to be hooked to one another to secure the sleeve formed by body 160 in a closed state. In other implementations, other forms of a hook or latch may be employed to secure the sleeve in a closed state. In some implementations, break connector 394 may be omitted.

FIG. 14 illustrates portions of an example climbing stick 420. FIG. 14 illustrates how clip 140 (or clips 240 or 340) may be utilized with a climbing stick having pivotable steps. Climbing stick 420 is similar to climbing stick 120 except that post 22 is shorter, climbing stick 420 omits middle step 34, and that climbing stick 420 includes pivoting steps 434 in place of steps 34. Those remaining components of climbing stick 420 which correspond to components of climbing stick 120 are numbered similarly.

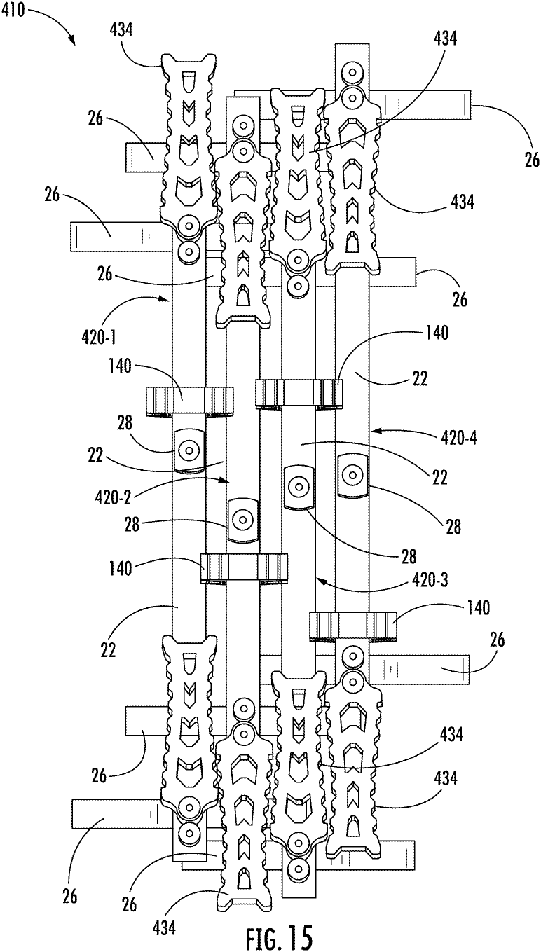

Pivoting steps 434 inch comprise a rigid member configured to pivot relative to post 22 between an extended, in-use state shown in FIG. 15 and an inactive or withdrawn state shown in FIG. 15. In the in use state shown in FIG. 15, steps 434 may be pivoted to either the left side or the right side of post 22. When in either of the left side position of the right side position, steps 434 are supported in a substantially horizontal orientation, an orientation perpendicular to the longitudinal axis of post 22, by stoppers 435.

FIG. 15 illustrates an example climbing stick system 410 formed by four individual climbing sticks 420-1, 420-2, 420-3 and 420-4 (collectively referred to as climbing sticks 420) interconnected to one another by their respective clips 140. Each of climbing sticks 420 is substantially identical to climbing stick 420 shown and described with respect to FIG. 14. As shown by FIG. 15, steps 434 may be pivoted to inactive positions in which the longitudinal axes of steps 434 extend substantially parallel to or coincident with the longitudinal axes of posts 22. As result, climbing sticks 420 may be part of a set or system of climbing sticks 420 that has a smaller profile or footprint during transport and storage. Upon reaching the tree upon which sticks 420 are to be secured, 64 20 may be easily separated from one another by pulling and withdrawing post 22 from the channels 170 of clips 140. Thereafter, the individual climbing sticks 420 may be secured along a tree trunk in an end-two-end fashion with steps 434 pivoted to the active states shown in FIG. 15, wherein the step 434 alternate between the left and right sides to form a ladder for sending the tree.

Although the present disclosure has been described with reference to example implementations, workers skilled in the art will recognize that changes may be made in form and detail without departing from the disclosure. For example, although different example implementations may have been described as including features providing various benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

What is claimed is:

1. A climbing stick comprising:
a first post;
claws projecting from the first post;
a first step extending from the first post;
a second step extending from the post; and
a clip for releasably connecting the first post of the climbing stick to a second post of a second climbing stick, the clip comprising:
a body connected to the first post; and
a pair of spaced resiliently flexible grippers extending from the body and forming a channel facing in a direction and sized to receive the second post of the second climbing stick while the pair of spaced resiliently flexible grippers grip opposite sides of the second post of the second climbing stick.

2. The climbing stick of claim 1, wherein the body is rotatably coupled to the first post for rotation between a first position in which a centerline of the channel extends parallel to a centerline of the first post and a second position in which the centerline of the channel extends perpendicular to the centerline of the first post.

3. The climbing stick of claim 2 further comprising:
a second clip for releasably connecting the first post of the climbing stick to a third post of a third climbing stick, the second clip comprising:
a second body to be connected to the first post; and
a second pair of spaced resiliently flexible grippers forming a second channel sized to receive the third post of the third climbing stick while the second pair of spaced resiliently flexible grippers grip opposite sides of the third post of the second climbing stick, wherein the second body is rotatably coupled to the first post for rotation between a first position in which a centerline of the second channel extends parallel to the centerline of the first post and a second position in which the centerline of the second channel extends perpendicular to the centerline of the first post.

4. The tree climbing stick of claim 3, wherein the second clip is mounted to the first post directly opposite the clip.

5. The climbing stick of claim 1 further comprising:
a second clip for releasably connecting the first post of the climbing stick to a third post of a third climbing stick, the second clip comprising:
a second body to be connected to the first post; and
a second pair of spaced resiliently flexible grippers forming a second channel sized to receive the third post of the third climbing stick while the second pair of spaced resiliently flexible grippers grip opposite sides of the third post of the second climbing stick.

6. The climbing stick of claim 1, wherein the body comprises a sleeve configured to slide along the first post.

7. The climbing stick of claim 6, wherein the sleeve continuously extends about post in an uninterrupted fashion.

8. The climbing stick of claim 6, wherein the sleeve has opposite edge portions separated by break.

9. The climbing stick of claim 6, wherein the sleeve comprises first and second sleeve portions joined by a hinge.

10. The climbing stick of claim 6, wherein the clip further comprises a second pair of spaced resiliently flexible grippers forming a second channel sized to receive a third post of a third climbing stick while the second pair of spaced resiliently flexible grippers grip opposite sides of the third post of the third climbing stick.

11. The climbing stick of claim 10, wherein the clip further comprises a third channel facing in a third direction perpendicular to the first direction and opposite overhangs to grip about a cinch mount head of a third climbing stick.

12. The climbing stick of claim 11, wherein the first channel has a first depth and wherein the third channel has a second depth less than the first depth.

13. The climbing stick of claim 6, wherein the sleeve has a rectangular cross-section.

14. The climbing stick of claim 1, wherein the clip further comprises a cinch mount head connector projecting from the first post in a second direction perpendicular to the first direction, the cinch mount head connector being configured to receive a cinch mount head of a second climbing stick.

15. A tree climbing stick system comprising:
a first tree climbing stick having a first post and a first plurality of steps coupled to the post;
a second tree climbing stick having a second post and a second plurality of steps coupled to the post;
a third tree climbing stick having a third post, a cinch mount extending from the third post, and a third plurality of steps coupled to the third post; and
a clip carried by the first post, the clip having a first open channel facing in a first direction and removably receiving the second post, a second open channel facing in a second direction opposite the first direction and removably receiving the third post, and a third channel extending along an axis perpendicular to the first direction and the second direction, the third channel configured to receive portions of a cinch mount of a fourth tree climbing stick.

16. A clip for releasably connecting multiple tree climbing sticks in parallel, the clip comprising:
a body to be connected to a first post of a first climbing stick; and
a pair of spaced resiliently flexible grippers extending from the body and forming a channel facing in a direction and sized to receive a second post of a second climbing stick while the pair of spaced resiliently flexible grippers grip opposite sides of the second post of the second climbing stick.

17. The clip of claim 16 further comprising a cinch mount head connector projecting from the body in a second direction perpendicular to the first direction, the cinch mount head connector being configured to receive a cinch mount head of a third climbing stick.

18. The clip of claim 17 further comprising a second pair of spaced resiliently flexible grippers extending from the body and forming a second channel facing a third direction opposite the first direction, the second channel being sized to receive a third post of a third climbing stick while the pair of spaced resiliently flexible grippers grip opposite sides of the third post of the third climbing stick.

19. The clip of claim 16 further comprising a second pair of spaced resiliently flexible grippers extending from the body and forming a second channel facing a second direction opposite the first direction, the second channel being sized to receive a third post of a third climbing stick while the pair of spaced resiliently flexible grippers grip opposite sides of the third post of the third climbing stick.

20. The clip of claim 16, wherein the body comprises a sleeve configured to slide along the first step of the first climbing stick.
